(19) United States
(12) Patent Application Publication
(10) Pub. No.: US 2011/0258859 A1
(43) Pub. Date: Oct. 27, 2011

(54) CUTTING DEVICE AND METHOD

(76) Inventors: Robert Theodore Schofield, Brooklyn, WI (US); James Charles Boda, Merrimac, WI (US)

(21) Appl. No.: 12/765,625

(22) Filed: Apr. 22, 2010

(51) Int. Cl. B26B 15/00; B26D 5/08; B23P 19/04; B27B 19/09

(52) U.S. Cl. 30/228; 30/394; 83/571; 29/700

(57) ABSTRACT

A cutting device and method uses a power tool releasably engageable with a shank or drive shaft of a mechanical assembly powering a movable cutting blade. The cutting device can include a drive shaft drivably coupled to the cutting blade, a neck supporting the drive shaft, and a shank having a first portion fixed relative to the neck and a second portion drivably coupled to and rotatable with the drive shaft, wherein the drive shaft and/or the second portion of the shank is shaped and dimensioned for releasable engagement with the power tool. In some cases, one or more gears are drivably coupled between the drive shaft and the cutting blade, and are operable to transfer rotation from the drive shaft to the cutting blade.

### BACKGROUND

Various cutting tools provide convenient ways to prune, trim, and perform other cutting tasks on trees, bushes, plants, and flowers. Such cutting tools often have a single movable blade cooperating with a stationary anvil, two moving blades, and the like, and include pruners, secateurs, loppers, and other tools. These devices are often strong enough to prune (cut) hard branches of trees and shrubs, and are used in gardening, arboriculture, farming, and nature conservation where relatively fine-scale habitat management is required.

One disadvantage of many current cutting devices is that they are often actuated manually by means of manually squeezing handles or levers of the cutting device together to generate a cutting action. Many conventional cutting devices typically have short handles and are operated with one hand, whereas others require two-handed operation (whether to grasp and compress two handles together, to hold a handle while manipulating a cord or rope, or otherwise). In some cases, a spring is used to cause at least one of the blades to move in an opening direction after being closed.

Many conventional cutting devices have long handles, and can be operated with both hands to perform cutting tasks. In many cases, these devices are large and inconvenient to carry around and/or store.

Also, the need to manually operate many conventional cutting devices and the size of longer cutting devices creates problems for some users when operating such devices for a long period of time or when users are cutting thicker media.

Although motorized cutting devices exist, wherein an integrated motor is used to automatically generate a cutting action of the tool, such motor operated cutting devices generally include more mechanical and electrical components (motor, battery, etc.), and can therefore be costly to manufacture. Other drawbacks of current motorized cutting devices include the weight and bulk of an electric motor and power source built into such cutting devices. Such built-in motors can be dedicated solely to the particular cutting device, often making the motor and/or power supply useful for nothing more than that particular tool. Based upon these and other limitations of conventional cutting devices, improved powered cutting devices continue to be welcome additions in the art.

On the other hand, standard hand-held power drills are used in (or accessible to) almost every household and business. Today, these power drills are often battery driven, although drills with electric power cords are also available. Thus, elements of a cutting device with a dedicated motor and power supply simply duplicate the role of many components of a conventional power drill. This adds cost, weight, and bulk to the equipment of a user. Therefore, it is desirable to provide an automatic cutting device that works with tools currently available to many users without unnecessarily adding to them.

### SUMMARY

Some embodiments of the present invention provide a cutting device adapted for coupling to a power tool, wherein the cutting device comprises a movable cutting blade; a drive shaft drivably coupled to the cutting blade; a neck supporting the drive shaft; and a shank having a first portion fixed relative to the neck and a second portion drivably coupled to and rotatable with the drive shaft, at least one of the drive shaft and the second portion of the shank shaped and dimensioned for releasable engagement with the power tool.

In some embodiments, a portable cutting device is provided, and comprises a drill having a motor and a chuck adapted to receive at least one tool bit; a movable cutting blade; a drive shaft drivably coupled to the cutting blade; a neck supporting the drive shaft; and a shank having a first portion fixed relative to the neck and a second portion drivably coupled to and rotatable with the drive shaft, at least one of the drive shaft and the second portion of the shank shaped and dimensioned to be received within the chuck of the drill for releasable engagement with the drill.

Some embodiments of the present invention provide a method of operating a cutting device, comprising adjusting a chuck of a power tool adapted to releasably receive and secure at least one tool bit; inserting a rotatable portion of a shank into the chuck of the power tool; tightening the chuck to secure the rotatable portion of the shank in the chuck; establishing a mechanical rotational connection between the chuck and a drive shaft by inserting and tightening the rotatable portion of the shank in the chuck of the power tool; rotating the drive shaft with the chuck; rotating a gear with the drive shaft; and rotating a cutting blade with the drive shaft.

Other aspects of the invention will become apparent by consideration of the detailed description and accompanying drawings.

### BRIEF DESCRIPTION OF THE DRAWINGS

FIG. 1 is a perspective view of a portable cutting device according to an embodiment of the present invention.

FIG. 2 is a perspective view of the cutting device of FIG. 1, shown attached to a hand-held drill.

FIG. 3 is an exploded view of the cutting device shown in FIGS. 1 and 2.

FIG. 4 is a perspective view of mechanical power transmission components of the cutting device of FIGS. 1-3.

FIG. 5 is a perspective view of a portable cutting device according to another embodiment of the present invention.

FIG. 6 is a perspective view of a portable cutting device according to yet another embodiment of the present invention.

### DETAILED DESCRIPTION

Before any embodiments of the invention are explained in detail, it is to be understood that the present invention is not limited in its application to the details of construction and the arrangement of components set forth in the following description or illustrated in the accompanying drawings. The present invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

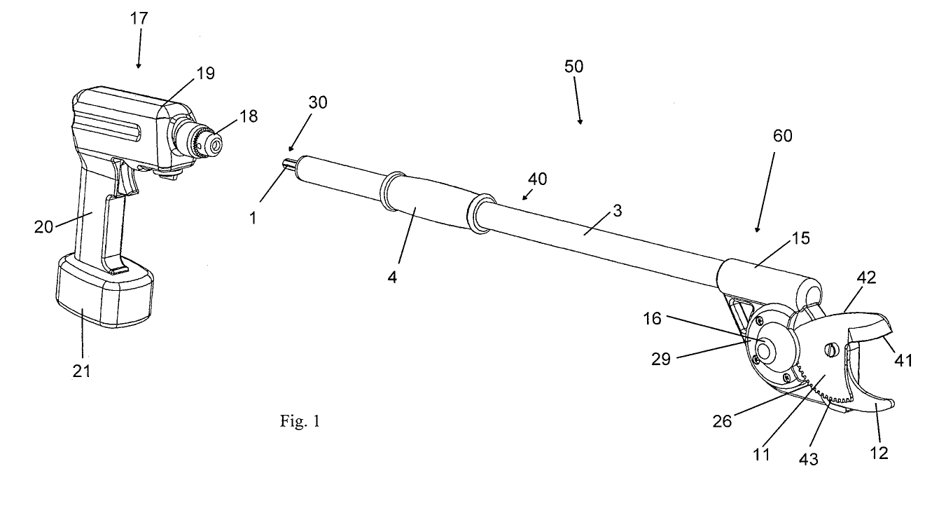

FIG. 1 illustrates a portable automatic cutting device 50 according to an embodiment of the present invention. The illustrated portable cutting device 50 is adapted for removable engagement with a standard hand-held power drill 17, and is also automatically driven by the drill 17. For the purposes of description, the proximal end of the cutting device 50 is considered the portion adjacent the drill 17 in FIG. 1, whereas the distal end of the cutting device 50 is opposite the proximal end, and carries a cutting blade 11 (described in greater detail below). Thus, references herein to “lateral” mean a direction that is transverse to the proximal/distal direction of the cutting device 50, whereas references herein to “longitudinal” mean a direction extending in the proximal/distal direction (e.g., parallel to the drive shaft 5, also described in greater detail below).

The drill 17 illustrated in FIG. 1 is a standard hand-held drill, and includes a chuck 18, a drill housing 19, and a drill handle 20. A battery 21 is attached to the bottom of the handle 20. In alternative embodiments, the drill 17 includes an electric power cord (not shown) instead of or in addition to the battery 21. In some embodiments, the chuck 18 of the drill can be adjusted (e.g., loosened and tightened) to release or secure a tool bit in the chuck 18. In connection with the cutting device 50 of the present invention, the chuck 18 can be adjusted to receive and drivably secure a shank 1 of the cutting device 50 or an end of a drive shaft 5 of the cutting device 50 in a similar manner.

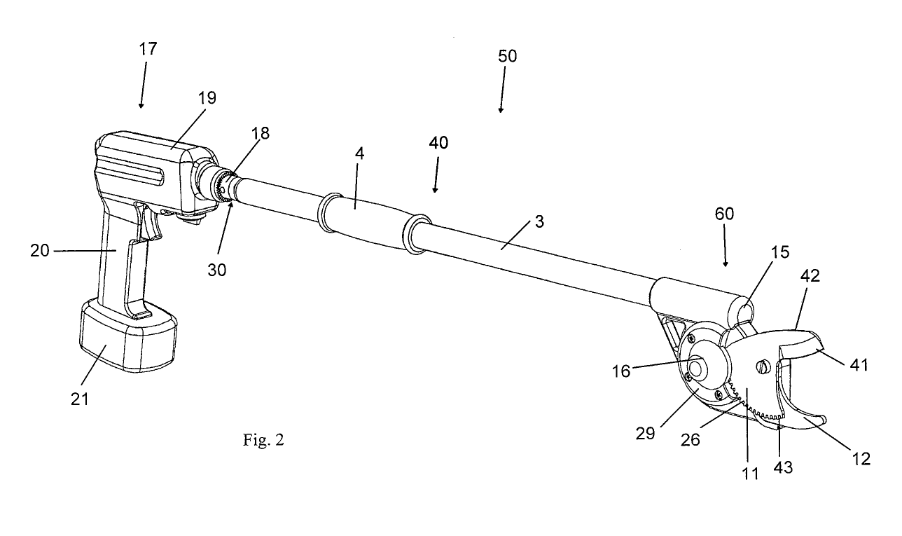

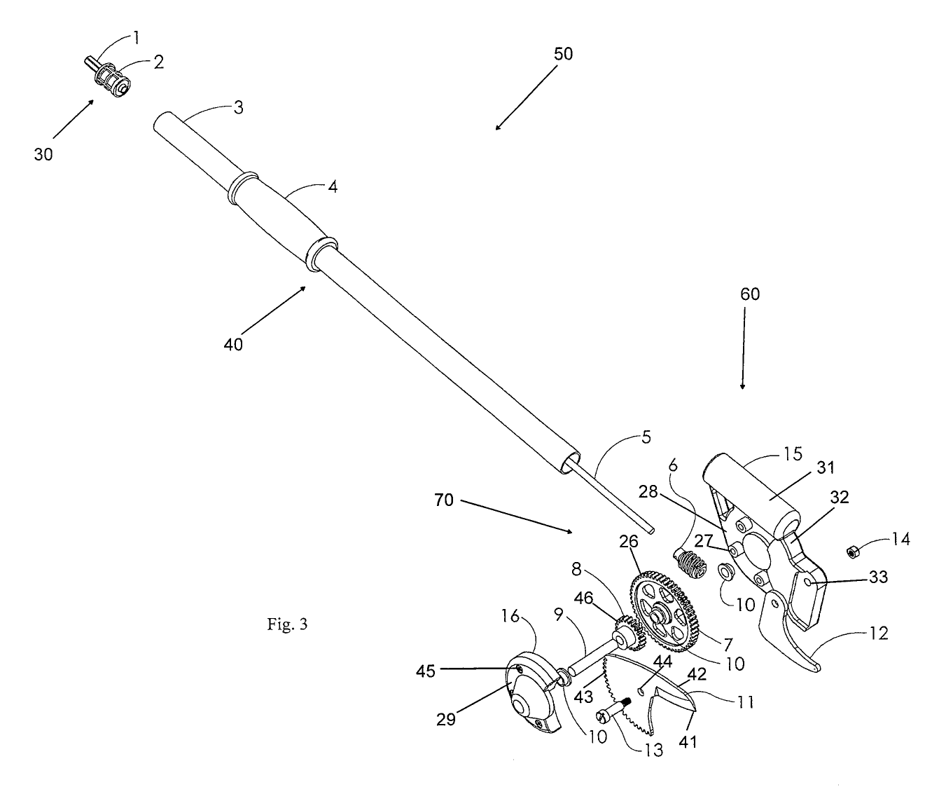

FIG. 1 further illustrates the general components of the cutting device 50. The cutting device 50 includes a shank assembly 30, a neck 40, and a cutting head 60. FIG. 1 shows the cutting device 50 when detached from the drill 17. FIG. 2 shows the cutting device 50 when attached to the drill 17. Attaching the illustrated cutting device 50 to the drill 17 is accomplished by the shank assembly 30. As shown in FIG. 3, the illustrated shank assembly 30 includes a shank 1 with a portion 2 that is rigidly fixed into a tube 3 of the neck 40 in a longitudinal direction. This rigidly fixed portion 2 can support the drive shaft 5 with respect to the rest of the cutting device 50, and can be a bearing within which the rotatable shank 1 is received. The drill chuck 18 is releasably mounted to the rotatable shank 1 coupled to the fixed portion 2 and the drive shaft 5 (the shank 1 is a terminal end of the drive shaft 5). In operation of the illustrated embodiment of FIGS. 1-4, the drill 17 transmits rotary power to the shank assembly 30 (by connection to the shank 1), and the shank 1 consequently transmits rotary power to the cutting device 50 through the drive shaft 5.

Although the shank assembly 30 illustrated in FIGS. 1-4 includes a shank 1 for releasable driving connection between the drill chuck 18 and the drive shaft 5, it should be appreciated that in other embodiments, the drive shaft 5 extends to and is directly connected to the drill chuck 18 in the same manner as described above in connection with the shank 1. In such embodiments, the drive shaft 5 can be rotatably supported anywhere along its length by one or more bearings, such as by a bearing located proximate the proximal end of the tube 3 where the illustrated shank assembly 30 is shown. However, by utilizing a shank assembly 30 to which the drive shaft 5 is connected, in some embodiments the shank assembly 30 can be disconnected from the drive shaft 5 as desired.

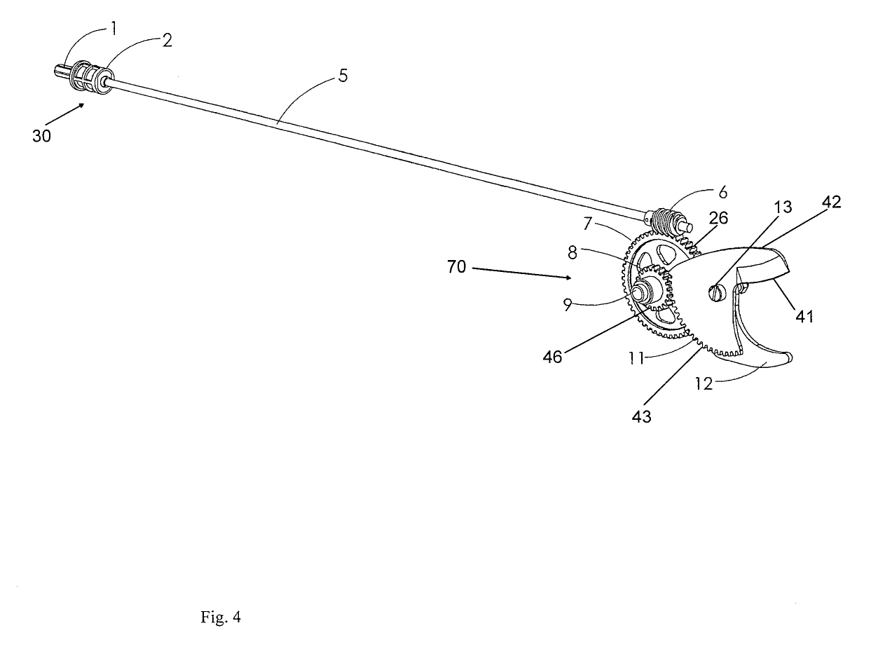

FIGS. 3 and 4 show the main components of the illustrated cutting device 50 in greater detail. The neck 40 of the illustrated cutter 50 includes an elongated tube 3 and a drive shaft 5. The elongated tube 3 can include a handle 4 providing the user with a gripping surface while holding the cutting device 50. The tube 3 generally connects the drill 17 and the cutting head 60 of the cutting device 50, whereas the drive shaft 5 is inserted within the tube 3 and connects the shank 1 to the cutting head 60. The tube 3 can be constructed of a single peace of aluminum, thereby reducing the complexity, weight, and cost of the cutting device 50 while providing a high degree of durability. In other embodiments, the tube 3 can be constructed of several pieces welded, threaded together, fastened together, or otherwise connected together in any suitable manner, and can be constructed of any other type of metal, plastic, fiberglass, composite materials, and the like. Also, in some embodiments, the tube 3 can be constructed of two or more portions that telescope with respect to one another, thereby enabling the user to change the length of the cutting device 50. In such cases, the drive shaft 5 can similarly be constructed of two or more telescoping tubes within the tube 3, or can be constructed of multiple pieces connected in end-to-end fashion in order to adjust the overall length of the drive shaft 5 with the tube 3.

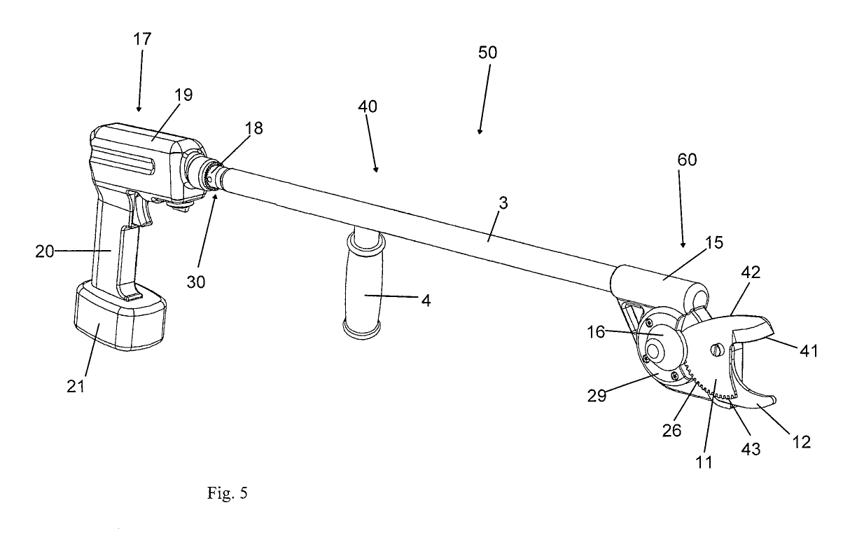

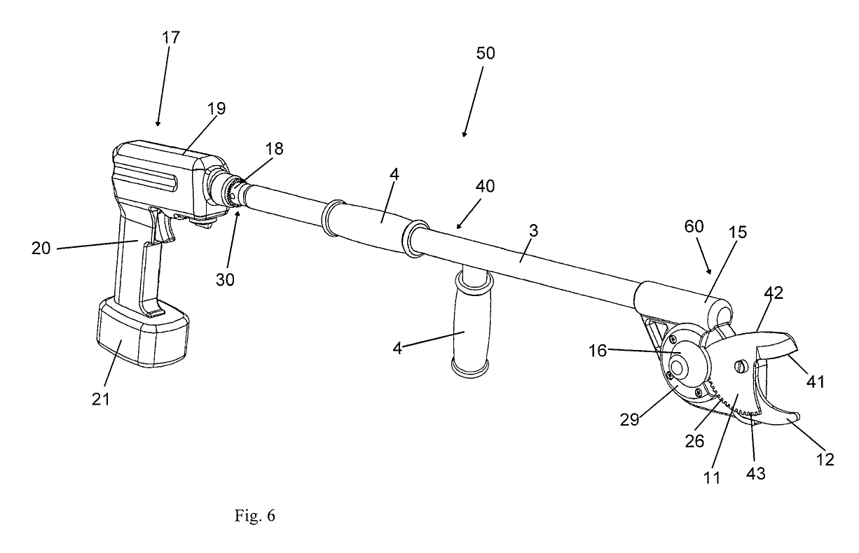

When utilized, the handle 4 can be designed to allow a user to easily and securely grasp the tube 3 and the cutting device 50. The handle 4 can generally be provided to enable a user to more securely support the cutting device 50 in use. Also, depending at least in part upon the shape and location of the handle 4, the handle 4 can allow a user to manually rotate the cutting device 50 in use. In the illustrated embodiment of FIGS. 1-4, the cutting device 50 includes one handle 4. In another exemplary embodiment (FIG. 6), the neck 40 of the cutting device 50 includes an additional handle 4 mounted in a location between the ends of the tube 3 (e.g., proximate the middle of the tube 3) and in an orientation that is perpendicular to the tube 3 and the drive shaft 5. This additional handle 4 can provide further support to a user, and can allow the user to operate the cutting device 50 with additional flexibility. In still another alternative embodiment (FIG. 5), the neck 40 of the cutting device 50 includes only the perpendicular handle 4.

With continued reference to the illustrated embodiment of FIGS. 1-4, the drive shaft 5 connects the shank assembly 30 with the cutting head 60 by a worm gear 6 at a distal end of the drive shaft 5. The worm gear 6 can provide sufficient rotational support to the distal end of the drive shaft 5, in some embodiments. Alternatively, the distal end of the drive shaft 5 can be supported by one or more bearings (not shown) located within the tube 3, within a housing 15 of the cutting head 60, or at least partially defined by the housing 15 of the cutting head 60. The worm gear 6 in the illustrated embodiment is one of a train of gears 70 used to transfer rotational mechanical power from the drive shaft 5 to the cutting blade 11. The drill 17 transmits rotary power to the shank 1 that rotates the drive shaft 5, which in turn provides rotational power to the gear train 70. More particularly, the worm gear 6 of the illustrated gear train 70 transfers rotational power to a first spur gear 7, which meshes with and provides rotational power to a second spur gear 8 meshing with and providing rotational power to gear teeth 46 on the cutting blade 11.

As shown in FIGS. 3 and 4, the illustrated cutting head 60 of the cutting device 50 includes a housing 15 mounted to the tube 3. The housing 15 can at least partially enclose the gear train 70, and in some embodiments completely encloses the gear train 70 while leaving an opening suitable for full movement of the cutting blade 11. The housing 15 is constructed from aluminum, steel, fiberglass, composite material, or any other suitable material.

The housing 15 can be constructed of any number of parts, such as a unitary housing 15 or a housing having a longitudinally-extending part line. In the illustrated embodiment, the housing includes two portions: a first portion defined by upper and middle portions 31, 32, and a gear cap 16 covering a side of the gear train 70.

The upper portion 31 of the housing 15 can have a tubular shape for receiving or being received by the distal end of the tube 3, thereby establishing a connection (with any suitable fasteners, threads, or other connecting elements) between the housing 15 and the tube 3. In the illustrated embodiments, the upper portion 31 of the housing 15 securely fits over and engages with the tube 3 in a longitudinal direction. Thus, the upper portion 31 receives the distal end of the drive shaft 5. The middle portion 32 of the housing 15 covers a side of the cutting head 60, and in some embodiments can be generally thinner than the upper portion 31, and can include openings 27 in an inner wall 28 for receiving screws (not shown) to secure the gear cap 16 to the rest of the housing 15. The screws can be inserted through openings 45 located in the outer wall 29 of the spur gear cap 16. The housing 15 (and more particularly, the middle portion 32 of the housing 15 in the illustrated embodiments) can also include a housing opening 33 holding a shoulder screw 13, pin, axle, or other pivot for rotatably securing the movable cutting blade 11 to the housing 15.

The illustrated cutting head 60 also includes an anvil 12. The anvil 12 is mounted to the housing 15, and provides a supporting surface that media rest against while being cut by the cutting blade 11. In the illustrated embodiments, the anvil 12 is connected to the housing 15 by the shoulder screw 13 and contoured surfaces features of the housing 15, but in alternative embodiments can be an integrated part of the housing 15.

FIG. 3 shows further details of the gear train 70. The illustrated gear train 70 includes a worm gear 6 coupled in a longitudinal direction to the drive shaft 5, and also coupled to the first spur gear 7. The first spur gear 7 in the illustrated embodiment is generally circular in shape, and includes a plurality of teeth 26 about its periphery. The worm gear 6 meshes with the teeth 26 of the first spur gear 7 and transfers rotary power received from the drive shaft 5 to the first spur gear 7. The first spur gear 7 in turn rotates an axle 9 supported by bushings 10 located at each end of the axle 9, although other locations of axle-supporting bushings 10 can instead be used as desired.

In some alternative embodiments, the worm gear 6 can disengage from the first spur gear 7 in order to prevent damage to the drive shaft 5 or the teeth 26 of the first spur gear 7 if the cutting device 50 is for any reason overpowered by the drill 17, or when the cutting blade 11 has moved through its full range of positions in either direction (opening or closing). In one embodiment, the first spur gear 7 can include a gap (not shown) in the teeth 26 of the first spur gear 7 corresponding to the fully open or fully closed position of the cutting blade 11. As another example, a clutch (also not shown) can be drivably coupled between the drive shaft 5 and the worm gear 6 (or at any other desired location along the drive train of the automatic cutting device 50). When there is too much torque acting on the cutting device 50 in such cases, the clutch can disengage, thereby avoiding potential damage to the drive shaft 5 or other components of the automatic cutting device. In still other alternative embodiments, the worm gear 6 can be connected to the drive shaft 5 via a spring (also not shown). With sufficient driving force between the worm gear 6 and the drive shaft 5, the spring can extend, thereby eventually disengaging the worm gear 6 from the spur gear 7, and interrupting mechanical power transmission. Still other mechanical power interrupting elements and devices can be used, and fall within the spirit and scope of the present invention.

With continued reference to the illustrated embodiments, a second spur gear 8 is mounted to the axle 9, and turns with rotation of the axle 9 generated by the first spur gear 7. The second spur gear 8 in the illustrated embodiments is generally circular in shape, and includes plurality of teeth 46 meshing with teeth 46 on the cutting blade 11.

In additional alternative embodiments, the cutting device 50 can include a clutch between the first spur gear 7 and the second spur gear 8 that prevents damage to the teeth 26 of the second spur gear 8 if the cutting device 50 is overpowered by the drill 17, such as when a user attempts to cut through a thicker and/or stronger workpiece. Also in some alternative embodiments, the cutting device 50 is designed without the second spur gear 8, in which cases the first spur gear 7 can directly mesh with and drive the cutting blade 11.

In the illustrated embodiment, the cutting blade 11 includes a cutting edge 41, a top edge 42, a connecting edge 43, and a blade opening 44. Teeth 46 on the connecting edge 43 of the illustrated cutting blade 11 mesh with the teeth 46 of the second spur gear 8, so that rotational motion from the second spur gear 8 drives the cutting blade 11. The cutting blade 11 can be attached and secured to the housing 15 by the shoulder screw 13 inserted through the blade opening 44 of the cutting blade 11 and the housing opening 33 of the housing 15. The shoulder screw 13 can be secured by a locknut 14 mounted on an outer wall of the housing 15. Thus, the cutting blade 11 is replaceable by removing the locknut 14 and the shoulder screw 13. The surface of the media being cut rests on the anvil 12 as the cutting edge 41 of the blade 11 is driven through the media by the rotating second spur gear 8.

In some methods of use of the cutting tools 50 illustrated in FIGS. 1-6, a user attaches the shank 1 of the cutting device 50 (or the proximal end of the drive shaft 5, in other embodiments) to the chuck 18 of the hand held drill 17. The user grasps the drill handle 20 with one hand, and either the horizontal or the perpendicular handle 4 of the cutting device 50 with the other hand. The user then points the cutting device 50 to a media, positions the media between the cutting blade 11 and the anvil 12, and presses the trigger of the drill 17. The drill 17 transmits rotary power to the shank, thereby rotating the drive shaft 5 that in turn drives the gear train 70 to rotate the cutting blade 11. The anvil 12 provides a surface against which the media being cut can rest as the cutting blade 11 is driven through the media by the rotating spur gear 8. When the user desires to cease cutting, the user releases the trigger of the drill 17.

The embodiments of the present invention described above and illustrated in the accompanying figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, in some alternative embodiments, the cutting device 50 can include more than one movable blade 11 driven by the drive shaft 5 via a suitable gear train. As an example, the cutting device 50 can include two blades that overlap one another in a scissors relationship, whereby the two blades pass each other to make a cut.

Also, the blade 11 of the cutting device 50 can have any other shape and size different from that shown in FIGS. 1-6. For example, the blade 11 can be straight or can be curved to have a convex or concave profile facing a workpiece received between the blade 11 and the anvil 12, such as a concave blade 11 facing a concave anvil, thereby trapping trap a workpiece therebetween to make a cut. Furthermore, any of the blades 11 described and/or illustrated herein can be provided with teeth or serrations to improve workpiece retention under some conditions.

As yet another example, the gear train 70 described and illustrated herein can take other forms equally suitable for transferring rotational power from the drive shaft 5 to one or more cutting blades 11. Such alternative gear trains 70 can employ gears having any shape and size suitable for this purpose, can have fewer or more gears of the same or different types shown in FIGS. 1-6, and need not necessarily define a gear reduction from the drive shaft 5 to the cutting blade(s) 11. It should also be appreciated that the gear trains 70 described and illustrated herein can be replaced with cam and follower elements (with or without gears) providing a similar transfer of mechanical power to the cutting blade 11.

What is claimed is:

1. A cutting device adapted for coupling to a power tool, the cutting device comprising:
a movable cutting blade;
a drive shaft drivably coupled to the cutting blade;
a neck supporting the drive shaft; and
a shank having a first portion fixed relative to the neck and a second portion drivably coupled to and rotatable with the drive shaft, at least one of the drive shaft and the second portion of the shank shaped and dimensioned for releasable engagement with the power tool.

2. The cutting device of claim 1, further comprising a gear drivably coupled between the drive shaft and the cutting blade and operable to transfer rotation from the drive shaft to the cutting blade.

3. The cutting device of claim 2, wherein the gear is part of a gear set drivably coupled between the drive shaft and the cutting blade and operable to transfer rotation from the drive shaft to the cutting blade.

4. The cutting device of claim 3, wherein the gear set defines a gear reduction from the drive shaft to the movable cutting blade.

5. The cutting device of claim 1, wherein the neck includes at least one handle positioned either parallel or perpendicular to the neck and the drive shaft.

6. The cutting device of claim 1, wherein the neck comprises at least two portions that telescope with respect to one another to change a length of the cutting device.

7. The cutting device of claim 1, wherein the second portion of the shank receives rotary power from the power tool when connected thereto, and transmits the rotary power to the cutting blade via the drive shaft.

8. The cutting device of claim 2, further comprising a housing at least partially enclosing the gear.

9. The cutting device of claim 8, wherein the housing includes a portion engaged with the neck to accept an end of the drive shaft.

10. The cutting device of claim 1, further comprising a stationary anvil cooperating with the cutting blade to sever a workpiece therebetween.

11. A portable cutting device, comprising:
a drill having a motor and a chuck adapted to receive at least one tool bit;
a movable cutting blade;
a drive shaft drivably coupled to the cutting blade;
a neck supporting the drive shaft; and
a shank having a first portion fixed relative to the neck and a second portion drivably coupled to and rotatable with the drive shaft, at least one of the drive shaft and the second portion of the shank shaped and dimensioned to be received within the chuck of the drill for releasable engagement with the drill.

12. The cutting device of claim 11, further comprising a gear drivably coupled between the drive shaft and the cutting blade and operable to transfer rotation from the drive shaft to the cutting blade.

13. The cutting device of claim 12, wherein the gear is part of a gear set drivably coupled between the drive shaft and the cutting blade and operable to transfer rotation from the drive shaft to the cutting blade.

14. The cutting device of claim 13, wherein the gear set defines a gear reduction from the drive shaft to the movable cutting blade.

15. The cutting device of claim 11, wherein the neck includes at least one handle positioned either parallel or perpendicular to the neck and the drive shaft.

16. The cutting device of claim 11, wherein the second portion of the shank receives rotary power from the power tool, and transmits the rotary power to the cutting blade via the drive shaft.

17. The cutting device of claim 12, further comprising a housing at least partially enclosing the gear.

18. The cutting device of claim 17, wherein the housing includes a portion engaged with the neck to accept an end of the drive shaft.

19. The cutting device of claim 11, further comprising a stationary anvil cooperating with the cutting blade to sever a workpiece therebetween.

20. A method of operating a cutting device, comprising:
adjusting a chuck of a power tool adapted to releasably receive and secure at least one tool bit;
inserting a rotatable portion of a shank into the chuck of the power tool;
tightening the chuck to secure the rotatable portion of the shank in the chuck;
establishing a mechanical rotational connection between the chuck and a drive shaft by inserting and tightening the rotatable portion of the shank in the chuck of the power tool;
rotating the drive shaft with the chuck;
rotating a gear with the drive shaft; and
rotating a cutting blade with the drive shaft.

21. The method of claim 20, wherein the shank is a terminal end of the drive shaft.
